(19) United States
(12) Patent Application Publication
(10) Pub. No.: US 2019/0102710 A1
(43) Pub. Date: Apr. 4, 2019

(54) EMPLOYER RANKING FOR INTER-COMPANY EMPLOYEE FLOW

(71) Applicant: Microsoft Technology Licensing, LLC, Redmond, WA (US)

(72) Inventors: Sebastian Predescu, San Francisco, CA (US); Jeremy Lwanga, San Francisco, CA (US); Michael Jennings, San Francisco, CA (US); Ted Tomlinson, Oakland, CA (US); Ching-Hui Hsu, New York, NY (US)

(21) Appl. No.: 15/791,670

(22) Filed: Oct. 24, 2017

Related U.S. Application Data
(60) Provisional application No. 62/566,364, filed on Sep. 30, 2017.

(51) Int. Cl. G06Q 10/06; G06Q 50/00; G06Q 10/10

(52) U.S. Cl. CPC G06Q 10/063; G06Q 10/1053; G06Q 50/01

(57) ABSTRACT

Methods, systems, and computer programs are presented for generating company-comparison reports based on a company ranking for hiring and retaining employees. One method includes an operation for determining transitions of users of a social network based on their profiles. Each transition comprises a change of employment from a source to a destination company. A transition graph is created, for a group of companies, including a node for each company and links between the nodes. Each link comprises a number of employees that transitioned from the source to the destination company. A weight, calculated for each link in the transition graph, is based on a number of employees of the destination company and a number of users transitioning between companies (both directions). A company score is calculated for each company based on the transition graph and the weights of the links. A report based on the company scores is then presented.

### CLAIM OF PRIORITY

This application claims priority from U.S. Provisional Patent Application No. 62/566,364, filed Sep. 30, 2017, and entitled “Employer Ranking for Inter-Company Employee Flow.” This provisional application is herein incorporated by reference in its entirety.

### TECHNICAL FIELD

The subject matter disclosed herein generally relates to methods, systems, and programs for analyzing company performance in regards to hiring and employee retention.

### BACKGROUND

Employment market data is very important for fast growing companies because these companies want to understand employment-related data, such as what is the population for a given skill set, where are potential employees located, what is the typical compensation, are people for a certain skill changing jobs often, etc. Further, a good understanding of the labor market may assist a company deciding where to establish a new site because the company may choose a site with a readily-available workforce.

However, employment data is usually kept secret by most companies, which merely provide, sometimes, the number of employees of the company. Therefore, getting a thorough understanding of the labor market based on available skills and geography is a difficult task.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments, including a social networking server.

FIG. 2 is a screenshot of a user's profile, according to some example embodiments.

FIG. 3 illustrates data structures for storing job and member information, according to some example embodiments.

FIG. 4 is a graph for employee transitions between companies, according to some example embodiments.

FIG. 5 illustrates the calculation of the transmission weight for transitions between two companies, according to some example embodiments.

FIG. 6 is a flowchart of a method for generating reports based on the company ranking, according to some example embodiments.

FIG. 7 is a graph for employee transitions between companies with retention links, according to some example embodiments.

FIG. 8 is a flowchart of a method for generating company-comparison reports based on company ranking for hiring and retaining employees, according to some example embodiments.

FIG. 9 is a chart showing the evolution of the company score over time for several companies, according to some example embodiments.

FIG. 10A is a report representing employee inflow over time for a plurality of companies, before smoothing, according to some example embodiments.

FIG. 10B is a report representing employee inflow over time for a plurality of companies after smoothing, according to some example embodiments.

FIG. 11 is a talent pool report, according to some example embodiments.

FIG. 12 is a talent geographic map, according to some example embodiments.

FIG. 13 is a talent-distribution report by company, according to some example embodiments.

FIG. 14 is a talent report by educational institution, according to some example embodiments.

FIG. 15 is a talent report by user skill, according to some example embodiments.

FIG. 16 is a workforce-distribution report for a company, according to some example embodiments.

FIG. 17 is a timeline for hires and departures of a given company, according to some example embodiments.

FIG. 18 is a company report by function, according to some example embodiments.

FIG. 19 is a report for talent flow between companies, according to some example embodiments.

FIG. 20 is a block diagram illustrating a representative software architecture, which may be used in conjunction with various hardware architectures herein described.

FIG. 21 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Example methods, systems, and computer programs are directed to generating company-comparison reports based on company ranking for hiring and retaining employees. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

The data from a social network is utilized to identify labor market parameters. The social network allows users to enter their job history into their profile, including jobs held, dates for the jobs, and job titles. This job history is used to identify job transitions for the users, and these job transitions are used to identify user migrations between companies (e.g., number of users that went from one company to another in a given quarter). The data is analyzed to provide employment reports based on user job transitions. Additionally, the transitions from, and to, a company are used to determine a company score, also referred to herein as employer brand ranking or desirability score, which indicates if the company is adding or losing employees and how well the company is able to retain existing employees over time.

The reporting tool helps talent-acquisition professionals understand labor market trends, identify talent pools, and understand how talent flows to and from companies. The employer brand ranking is defined by a company's desirability by talent, e.g., how attractive the company is to skilled professionals and the ability of the company to hire and retain talent. The performance of the company over time, with reference to the employer brand ranking, is tracked over time and presented in numerical, tabular, and graphical forms.

In one embodiment, a method includes an operation for determining transitions of users of a social network based on a profile of each user. Each transition comprises a change of employment from a source company to a destination company. Further, the method includes an operation for creating a transition graph for a group of companies, the transition graph comprising a node for each company and links between the nodes. Each link between two companies comprises a number of employees that transitioned from the source company to the destination company. Additionally, the method includes an operation for calculating a weight for each link in the transition graph. The weight is based on a number of employees of the destination company, a number of users transitioning from the source company to the destination company, and a number of users transitioning from the destination company to the source company. Furthermore, a company score is calculated for each of the companies based on the transition graph and the weights of the links. The method further includes an operation for causing presentation of a report based on the company scores.

In another embodiment, a system comprises a memory having instructions and one or more computer processors. The instructions, when executed by the one or more computer processors, cause the one or more computer processors to perform operations comprising: determining transitions of users of a social network based on a profile of each user, each transition comprising a change of employment from a source company to a destination company; creating a transition graph for a group of companies, the transition graph comprising a node for each company and links between the nodes, each link between two companies comprising a number of employees that transitioned from the source company to the destination company; calculating a weight for each link in the transition graph, the weight being based on a number of employees of the destination company, a number of users transitioning from the source company to the destination company, and a number of users transitioning from the destination company to the source company; calculating a company score for each of the companies based on the transition graph and the weights of the links; and causing presentation of a report based on the company scores.

In yet another embodiment, a non-transitory machine-readable storage medium including instructions that, when executed by a machine, cause the machine to perform operations comprising: determining transitions of users of a social network based on a profile of each user, each transition comprising a change of employment from a source company to a destination company; creating a transition graph for a group of companies, the transition graph comprising a node for each company and links between the nodes, each link between two companies comprising a number of employees that transitioned from the source company to the destination company; calculating a weight for each link in the transition graph, the weight being based on a number of employees of the destination company, a number of users transitioning from the source company to the destination company, and a number of users transitioning from the destination company to the source company; calculating a company score for each of the companies based on the transition graph and the weights of the links; and causing presentation of a report based on the company scores.

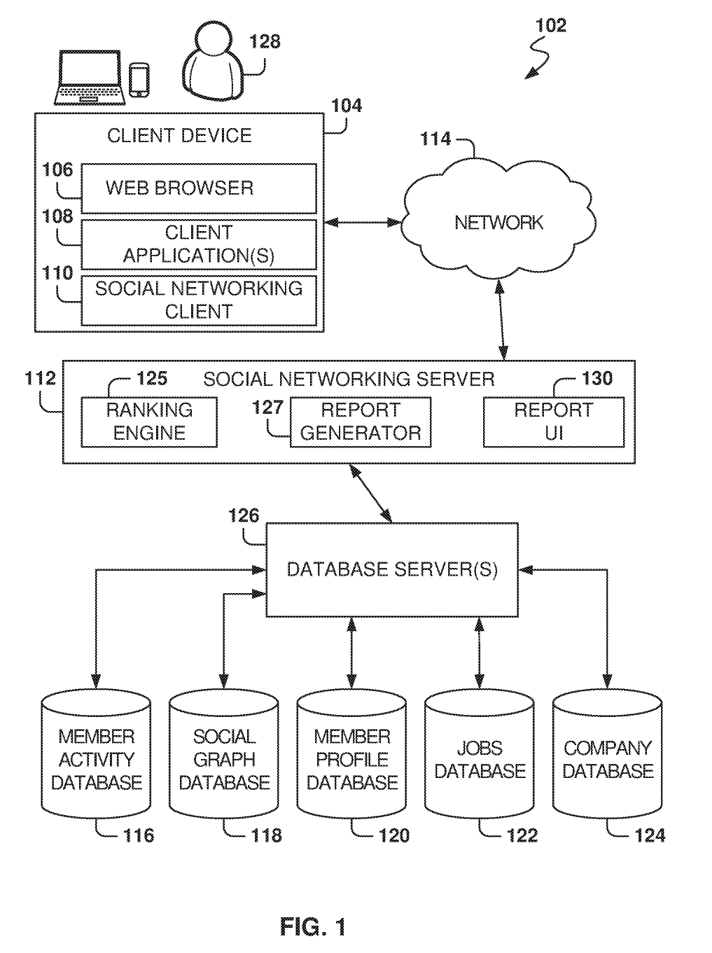

FIG. 1 is a block diagram illustrating a networked system, according to some example embodiments, including a social networking server 112, illustrating an example embodiment of a high-level client-server-based network architecture 102. The social networking server 112 provides server-side functionality via a network 114 (e.g., the Internet or a wide area network (WAN)) to one or more client devices 104. FIG. 1 illustrates, for example, a web browser 106, client application(s) 108, and a social networking client 110 executing on a client device 104. The social networking server 112 is further communicatively coupled with one or more database servers 126 that provide access to one or more databases 116-124.

The client device 104 may comprise, but is not limited to, a mobile phone, a desktop computer, a laptop, a portable digital assistant (PDA), a smart phone, a tablet, a netbook, a multi-processor system, a microprocessor-based or programmable consumer electronic system, or any other communication device that a user 128 may utilize to access the social networking server 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, global positioning system (GPS) devices, and so forth.

In one embodiment, the social networking server 112 is a network-based appliance that responds to initialization requests or search queries from the client device 104. One or more users 128 may be a person, a machine, or other means of interacting with the client device 104. In various embodiments, the user 128 is not part of the network architecture 102, but may interact with the network architecture 102 via the client device 104 or another means. For example, one or more portions of the network 114 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 104 may include one or more applications (also referred to as “apps”) such as, but not limited to, the web browser 106, the social networking client 110, and other client applications 108, such as a messaging application an electronic mail (email) application, a news application, and the like. In some embodiments, if the social networking client 110 is present in the client device 104, then the social networking client 110 is configured to locally provide the user interface for the application and to communicate with the social networking server 112, on an as-needed basis, for data and/or processing capabilities not locally available (e.g., to access a member profile, to authenticate a user 128, to identify or locate other connected members, etc.). Conversely, if the social networking client 110 is not included in the client device 104, the client device 104 may use the web browser 106 to access the social networking server 112.

Further, while the client-server-based network architecture 102 is described with reference to a client-server architecture, the present subject matter is of course not limited to such an architecture, and could equally well find application in a distributed, or peer-to-peer, architecture system, for example.

In addition to the client device 104, the social networking server 112 communicates with the one or more database server(s) 126 and database(s) 116-124. In one example embodiment, the social networking server 112 is communicatively coupled to a member activity database 116, a social graph database 118, a member profile database 120, a jobs database 122, and a company database 124. The databases 116-124 may be implemented as one or more types of databases including, but not limited to, a hierarchical database, a relational database, an object-oriented database, one or more flat files, or combinations thereof.

The member profile database 120 stores member profile information about members who have registered with the social networking server 112. With regard to the member profile database 120, the member may include an individual person or an organization, such as a company, a corporation, a nonprofit organization, an educational institution, or other such organizations.

Consistent with some example embodiments, when a user initially registers to become a member of the social networking service provided by the social networking server 112, the user is prompted to provide some personal information, such as name, age (e.g., birth date), gender, interests, contact information, home town, address, spouse's and/or family members' names, educational background (e.g., schools, majors, matriculation and/or graduation dates, etc.), employment history (e.g., companies worked at, periods of employment for the respective jobs, job title), professional industry (also referred to herein simply as “industry”), skills, professional organizations, and so on. This information is stored, for example, in the member profile database 120. Similarly, when a representative of an organization initially registers the organization with the social networking service provided by the social networking server 112, the representative may be prompted to provide certain information about the organization, such as a company industry. This information may be stored, for example, in the member profile database 120. In some embodiments, the profile data may be processed (e.g., in the background or offline) to generate various derived profile data. For example, if a member has provided information about various job titles that the member has held with the same company or different companies, and for how long, this information may be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

In some example embodiments, the company database 124 stores information regarding companies in the member's profile. A company may also be a member, but some companies may not be members of the social network although some of the employees of the company may be members of the social network. The company database 124 includes company information, such as name, industry, contact information, website, address, location, geographic scope, and the like.

As users interact with the social networking service provided by the social networking server 112, the social networking server 112 is configured to monitor these interactions. Examples of interactions include, but are not limited to, commenting on posts entered by other members, viewing member profiles, editing or viewing a member's own profile, sharing content outside of the social networking service (e.g., an article provided by an entity other than the social networking server 112), updating a current status, posting content for other members to view and comment on, posting job suggestions for the members, searching job posts, and other such interactions. In one embodiment, records of these interactions are stored in the member activity database 116, which associates interactions made by a member with his or her member profile stored in the member profile database 120. In one example embodiment, the member activity database 116 includes the posts created by the users of the social networking service for presentation on user feeds.

The jobs database 122 includes job postings offered by companies in the company database 124. Each job posting includes job-related information such as any combination of employer, job title, job description, requirements for the job, salary and benefits, geographic location, one or more job skills required, day the job was posted, relocation benefits, and the like.

In one embodiment, the social networking server 112 communicates with the various databases 116-124 through the one or more database server(s) 126. In this regard, the database server(s) 126 provide one or more interfaces and/or services for providing content to, modifying content in, removing content from, or otherwise interacting with the databases 116-124. For example, and without limitation, such interfaces and/or services may include one or more Application Programming Interfaces (APIs), one or more services provided via a Service-Oriented Architecture (SOA), one or more services provided via a Representational State Transfer (REST)-Oriented Architecture (ROA), or combinations thereof. In an alternative embodiment, the social networking server 112 communicates with the databases 116-124 and includes a database client, engine, and/or module, for providing data to, modifying data stored within, and/or retrieving data from the one or more databases 116-124.

While the database server(s) 126 is illustrated as a single block, one of ordinary skill in the art will recognize that the database server(s) 126 may include one or more such servers. For example, the database server(s) 126 may include, but are not limited to, a Microsoft® Exchange Server, a Microsoft® Sharepoint® Server, a Lightweight Directory Access Protocol (LDAP) server, a MySQL database server, or any other server configured to provide access to one or more of the databases 116-124, or combinations thereof. Accordingly, and in one embodiment, the database server(s) 126 implemented by the social networking service are further configured to communicate with the social networking server 112.

The social networking server 112 includes, among other modules, a ranking engine 125, a report generator 127, and a report user interface 130. The ranking engine 125 calculates the company scores over time for a plurality of companies, as described in more detail below. The report generator 127 generates the reports associated with the company scores and talent migrations, and the report user interface 130 provides an interface for accessing the reports and options for the report generation.

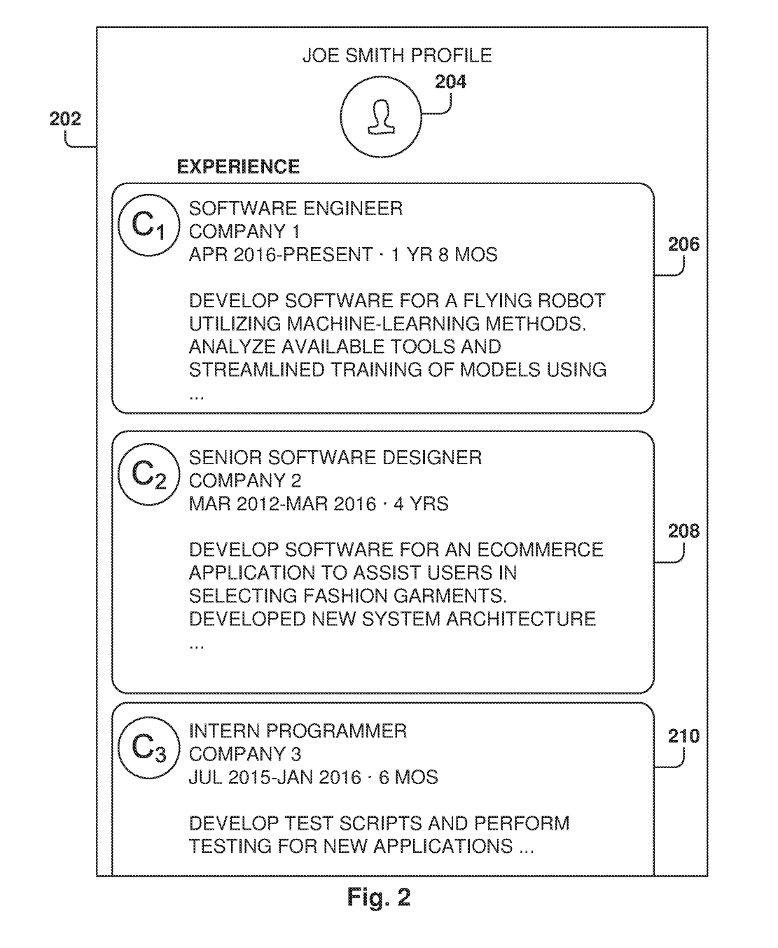

FIG. 2 is a screenshot 202 of a user's profile, according to some example embodiments. In the example embodiment of FIG. 2, the user's profile includes several jobs held by the user 204, in similar format to a generic resume.

In one example embodiment, each job (206, 208, 210) includes a company logo for the employer (e.g., C₁), a title (e.g., software engineer), the name of the employer (e.g., Company 1), dates of employment, and a description of the job tasks or job responsibilities of the user 204.

When users change jobs, the users tend to update their employment history, although updating may not happen right away. By analyzing the job changes, including end date and start dates, it is possible to identify transitions between companies.

In the exemplary embodiment of FIG. 2, it is observed that the job 208 as a senior software designer in Company 2 ended in March 2016, and the job 206 as a software engineer in Company 1 started on April 2016. Since the dates are close in time and the job titles are similar, it can be determined that the user transitioned from Company 1 to Company 2 in April 2016.

The social network analyzes the transitions for the users within the social network and aggregates this transitional data to generate reports based on employee migrations between companies, job titles, job skills, time intervals, etc.

In some example embodiments, the information on the user profiles may be categorized. For example, the company may include a company ID, a title may be assigned a title ID (where the title is standardized to cover a plurality of similar job titles), and a position may be assigned a position ID. In some example embodiments, each job (member_position) of the user may be described utilizing a record with one or more of the following fields: {member_id: int, position_id: int, company_id: int, is_current: boolean (indicating if this is believed to be the user's current job), industry_id: int, position_start_time: long, position_end_time: long}. Other embodiments may include additional fields or fewer fields.

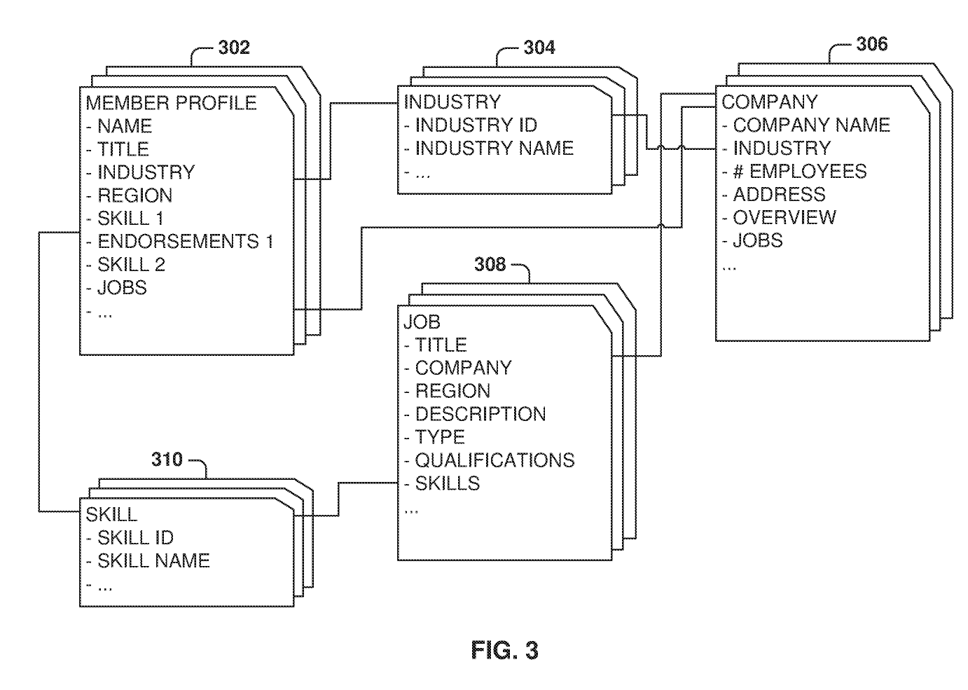

FIG. 3 illustrates data structures for storing job and member information, according to some example embodiments. Each user in the social network has a member profile 302, which includes information about the user. The user profile is configurable by the user and includes information based on the user activity in the social network (e.g., likes, posts read).

In one example embodiment, the member profile 302 may include information in several categories, such as experience, education, skills and endorsements, accomplishments, contact information, following, and the like. Skills include professional competences that the member has, and the skills may be added by the member or by other members of the social network. Example skills include C++, Java, Object Programming, Data Mining, Machine Learning, Data Scientist, and the like. Other members of the social network may endorse one or more of the skills and, in some example embodiments, the account is associated with the number of endorsements received for each skill from other members.

The member profile 302 includes member information, such as name, title (e.g., job title), industry (e.g., legal services), geographic region, jobs, skills and endorsements, and so forth. In some example embodiments, the member profile also includes job related data, such as employment history, jobs previously applied to, or jobs already suggested to the member (and how many times the job has been suggested to the member). Within member profile 302, the skill information is linked to skill data 310, the employer information is linked to company data 306, and the industry information is linked to industry data 304.

The experience information includes information related to the professional experience of the user. In one example embodiment, the experience information includes industry data 304, which identifies the industry in which the user works. In one example embodiment, the user is given an option to select an industry from a plurality of industries when entering this value in the profile. In other example embodiments, the user may also enter an industry that is not in the list of predefined industries. In some example embodiments, the industry is defined at a high level. Some examples of industries configurable in the user profile include information technology, mechanical engineering, marketing, and the like. The experience information area may also include information about the current job and previous jobs held by the user.

The skills data 310 and endorsements includes information about professional skills that the user has identified as having been acquired by the user, and endorsements entered by other users of the social network supporting the skills of the user. Accomplishments include accomplishments entered by the user, and contact information includes contact information for the user, such as email and phone number.

The industry data 304 is a table for storing the industries identified in the social network. In one example embodiment, the industry data 304 includes an industry identifier (e.g., a numerical value or a text string), and an industry name, which is a text string associated with the industry (e.g., legal services).

In one example embodiment, the company data 306 includes company information, such as company name, industry associated with the company, number of employees, address, overview description of the company, job postings, and the like. In some example embodiments, the industry is linked to the industry data 304.

The skill data 310 is a table for storing the different skills identified in the social network. In one example embodiment, the skill data 310 includes a skill identifier (ID) (e.g., a numerical value or a text string) and a name for the skill. The skill identifier may be linked to the member profile 302 and job data 308.

In one example embodiment, job data 308 includes data for jobs posted by companies in the social network. The job data 308 includes one or more of a title associated with the job (e.g., software developer), a company that posted the job, a geographic region for the job, a description of the job, a type of job, qualifications required for the job, and one or more skills. The job data 308 may be linked to the company data 306 and the skill data 310.

It is noted that the embodiments illustrated in FIG. 3 are examples and do not describe every possible embodiment. Other embodiments may utilize different data structures, fewer data structures, combine the information from two data structures into one, add additional or fewer links among the data structures, and the like. The embodiments illustrated in FIG. 3 should therefore not be interpreted to be exclusive or limiting, but rather illustrative.

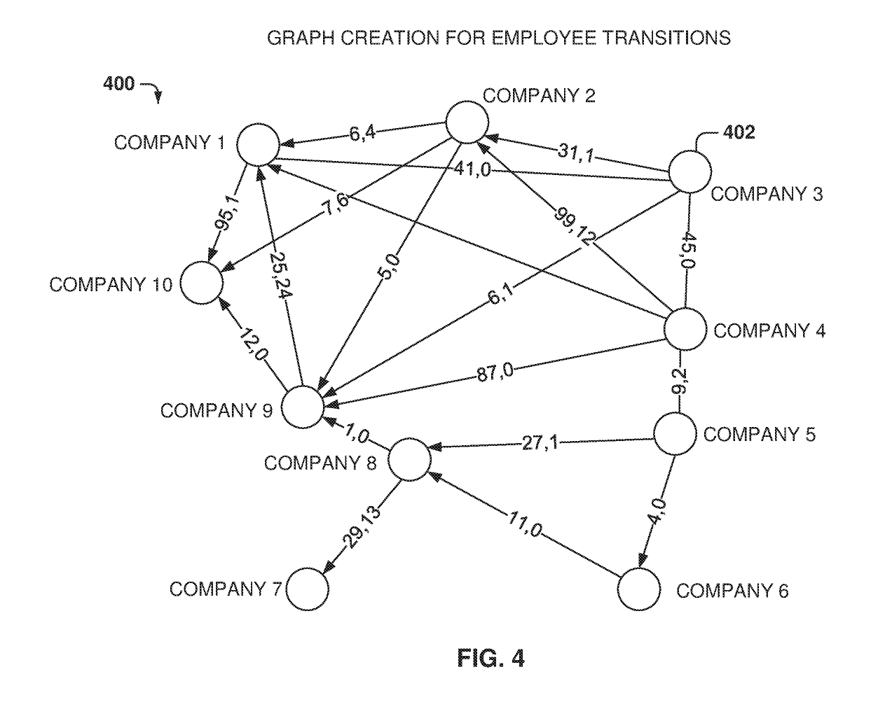

FIG. 4 is a graph 400 for employee transitions between companies, according to some example embodiments. In some example embodiments, graphs with nodes and interconnecting links between the nodes are created for generating the company score. The company score, also referred to herein as employer brand ranking, is a numerical value that measures the performance of a company for hiring and retaining talent. A high company score means that a company is hiring more employees than it is losing and that the company is able to retain employees.

In some example embodiments, a company score may be defined for the company as a whole. In other embodiments, the company score is defined for a particular super-title and geographical region. The super-title is a value assigned to a group of similar titles. For example, titles such as “software developer,” “application developer,” “programmer,” “software engineer,” “software analyst,” “Java programmer,” etc., may be mapped to a common super-title of “software developer.”

In some example embodiments, the company score is associated with a given timeframe, such as a quarter of the year, but other time periods may be utilized, such as annually, semi-annually, monthly, weekly, etc.

The nodes in the graph 400 are companies 402, and directional links, also referred to herein as edges, connect the nodes when there are employee transitions from a source company to a destination company. Each link is then associated with a count of the number of employees that move from the source company to the destination company.

There may be two links between two companies, each link flowing in a different direction. For simplicity, the two links have been combined in graph 400, and only one link is illustrated between the companies in the direction of the company that gained employees. In this representation, each link includes two values: a first value indicating the number of employees that went from one company to the company where the arrow is pointing, and a second value indicating the number of employees that changed jobs in the opposite direction. A zero value indicates that no employees were transferred in the corresponding direction.

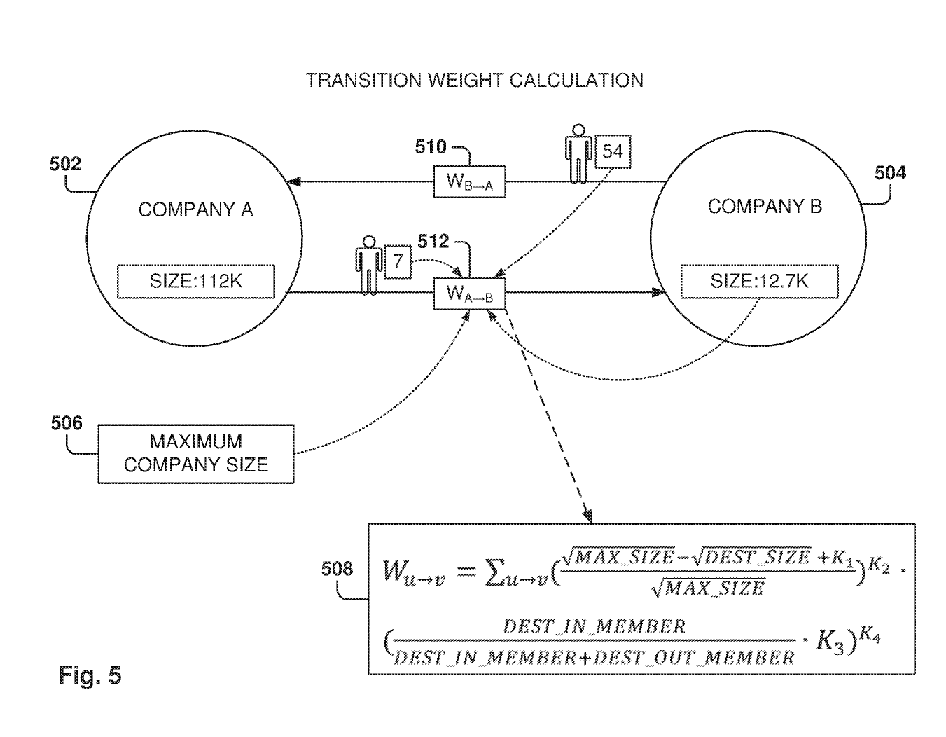

After the graph is built, several algorithms may be utilized to calculate the company score. One of those algorithms is based on the PageRank algorithm but modified based on calculated weights for the links, as described in more detail below with reference to FIG. 5. The PageRank algorithm gives each company a rating, which is recursively defined: a given company becomes important if talent from top-ranked companies (e.g., companies with a high company score) flow to the given company.

The PageRank algorithm was originally used by Google Search to rank websites in their search engine results. PageRank is a way of measuring the importance of website pages. PageRank works by counting the number and quality of links to a page to determine a rough estimate of how important the website is. The underlying assumption is that more important websites are likely to receive more links from other websites.

In PageRank, a graph is constructed where nodes are websites and the edges are a website having a link to another website. Initially, the more links that point to a website, the higher the score of the website will be. Further, not all the links are counted equally, because links from important or reputable websites (e.g., websites having a high score) affect the score of the website more than links from websites with lower scores.

As with PageRank, it matters where an employee comes from, and if an employee transitions from a company with a high score, the impact on the company receiving the employee will be higher than if the employee transitions from a company with a low score.

In some example embodiments, the graph is created for each quarter, and a record weighted_categories for a position transition includes one or more of the following fields: {member_id: int, country: chararray, fromNodeId: long, to NodeId: long, weight: double, category: chararray}. Using employee transfers between companies is a way to determine the relative strength of each business's talent brand, for a population of people with similar skills. However, if a company has a high score for attracting engineers, it may be the case that the company may have a low score for attracting salespeople.

Analyzing the flow of employees from one company to another provides an insight into employee's preferences for places to work, which is an indication of the talent brand for those companies.

FIG. 5 illustrates the calculation of the transmission weight for transitions between two companies, according to some example embodiments. Company A 502 and company B 504 have seen some employees migrating between the companies in a given time period. The weight of the link 512 representing the employees that went from Company A to Company B is represented as W_{A→B}, and the weight of the link 510 representing the employees that went from Company B to Company A is represented as W_{B→A}. In this case, 7 employees went from Company A to Company B and 54 employees migrated in the opposite direction.

The PageRank is modified by redefining the weighting W_{u→v} of each edge from Company u to Company v, such that the weight is proportional to the following:

$$\sqrt{MAX\_SIZE} - \sqrt{DEST\_SIZE} ;$$

$${( \frac{DEST\_IN \_MEMBER}{DEST\_IN \_MEMBER + DEST\_OUT \_MEMBER} \cdot {K}_{3} )}^{{K}_{4}} ;$$

and
Number of members flowing from source to destination

Here, MAX_SIZE is the maximum company size 506 for all the companies under consideration in the graph, DEST_SIZE is the number of employees for the given super-title at the destination company, DEST_IN_MEMBER is the number of incoming employees for the given super-title at the destination company v, and DEST_OUT_MEMBER is the number of outgoing employees from the destination company v.

In one example embodiment, the PageRank is modified by redefining the weighting W_{u→v} of each edge from Company u to Company v, according to the following equation (1):

$${W}_{u -> v} = {\sum }_{u -> v} {( \frac{\sqrt{MAX\_SIZE} - \sqrt{DEST\_SIZE} + 1}{\sqrt{MAX\_SIZE}} )}^{{K}_{2}} \cdot {( \frac{DEST\_IN \_MEMBER}{DEST\_IN \_MEMBER + DEST\_OUT \_MEMBER} \cdot {K}_{3} )}^{{K}_{4}}$$

Here, K₁-K₄ are tuning parameters that may be configured by the system administrator. The tuning parameters may have any value. In one example embodiment, K₁ is in the range of 1 to 100, K₂ is in the range of 1 to 10, K₃ in the range of 1-10, and K₄ is in the range of 1 to 20, but other values are also possible. For example, one combination may include K₁=15, K₂=3, K₃=2, and K₄=6. The parameters may be tuned to give more importance to different factors, such as the difference in size between source and destination company, and the ratio of incoming to outgoing employees.

It's noted that the weight of the edge is adjusted to consider more than just the number of employees flowing between companies by adjusting the weight based on the company size and the inflow or outflow of employees at the destination company. This is important, because an employee migrating from a small company may have a different impact than an employee from a large company.

The equation (1) above reflects whether the company is a growing company or a shrinking company. If it is a growing company, there are more hires than departures; because of K₃ and K₄, this factor is emphasized. However, if the net flow is 0 and K₃ is 2, then the result is a power of one, which becomes one and this factor would not affect the calculation.

Some companies may be constantly growing for a large number of recent quarters, and their talent brand score will be high. However, if a small startup hires 10 employees from a large, growing company, these 10 employees may boost considerably the score of the small startup. On the other hand, an increase often employees for a large employer may not have such a big impact on the company score.

If a company is able to hire from a growing company, this means that this company will have a large score because it is able to attract talent. On the other hand, if a company is hiring from a shrinking company (e.g., a company that appears to be going bankrupt), then these hires may not have such a big impact, because it is not difficult to hire from shrinking companies.

It is noted that other embodiments may utilize other equations in order to adjust the weights utilizing the principles presented above.

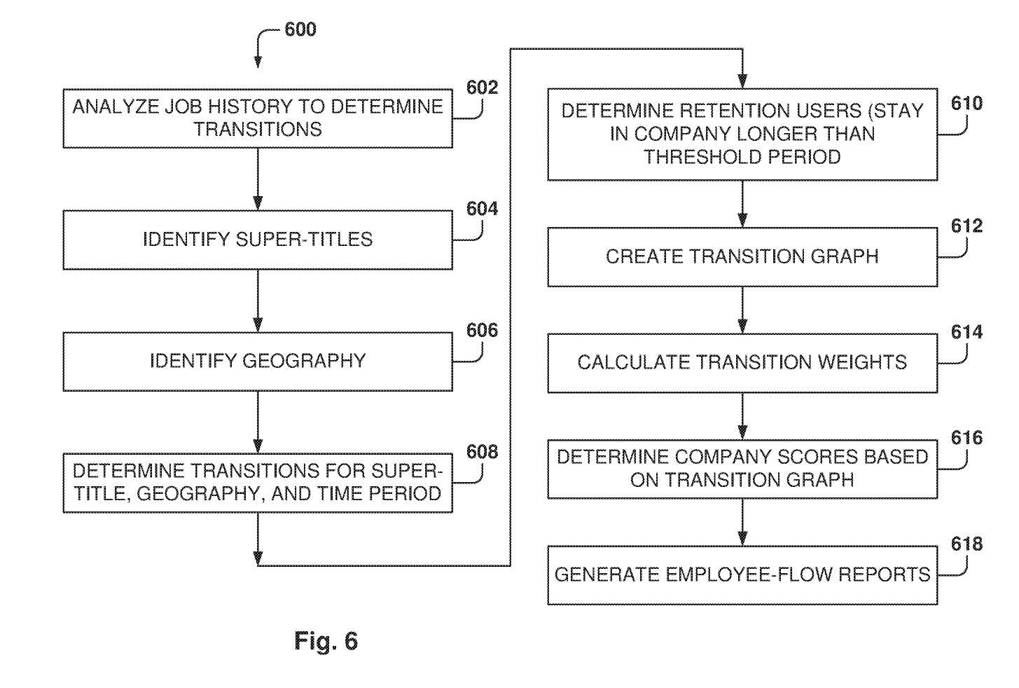

FIG. 6 is a flowchart of a method 600 for generating reports based on the company ranking, according to some example embodiments. While the various operations in this flowchart are presented and described sequentially, one of ordinary skill will appreciate that some or all of the operations may be executed in a different order, be combined or omitted, or be executed in parallel.

At operation 602, the job history of the users of the social network is analyzed to determine the transitions between companies. As discussed above with reference to FIG. 2, each user's employment history is analyzed to determine transitions.

At operation 604, the super-titles are identified for the titles identified in the employee's history. As discussed earlier, the super-titles are utilized to normalize the variations in the title name for similar jobs.

At operation 606, a geographical region is identified for the report and the calculation of the company score. For example, a national scope may be identified to analyze the flows within a country, but more specific regions may also be identified to determine flows (e.g., Silicon Valley transitions), or larger regions (e.g., transitions within Europe).

At operation 608, the transitions relevant to the identified super-title, geography, and time period are identified. Further, at operation 610, the retention of employees is determined, although this operation may be optional in some embodiments. In some example embodiments, the retention includes counting the number of employees that have remained at the job longer than a predetermined threshold period (e.g., three years, although other threshold periods are possible).

At operation 612, the transition graph is created as illustrated above with reference to FIG. 4. After the graph is created, based on the employee transitions, the transition weights are calculated. For example, the weights may be calculated utilizing equation (1) described above.

At operation 616, the company scores are calculated based on the transition graph and the calculated weights. In one example embodiment, the PageRank algorithm is utilized but modified with the calculated weights. In another embodiment, the Elo rating system is utilized.

The Elo rating system, named after its inventor, Arpad Elo, is a method for calculating the relative skill levels of players in competitor-versus-competitor games such as chess. In our case, the Elo rating system is used to measure the relative strength of companies based on the employee transitions. For example, in the Elo system, an edge in the players graph represents the probability of a player beating the other player. In our case, the edge represents the number of employees flowing from one company to the other. The edge is symbolized as a match between the two companies.

In this case, a series of matches are modeled, picking an arbitrary start time (e.g., January 2010). Initially, all companies have the same rating, such as 100. If an employee moves to another company, the destination company may have the score increased to 105 and the source company may have the score decreased to 95. In a sense, there is a score shifting based on the transition.

Later, an employee may transition from the company ranked 105 to another company. In this case, the destination company may have the score increased to 107 because the employee is coming from a high-ranked company. The process continues and all the transitions are modeled based on the Elo rating system. It is noted that the order in which the transitions happen is important because it measures the relative strengths of the companies at the time that the transition took place. Once all the transitions have been accounted for, each company has a respective company score. At operation 618, the employee-flow reports are generated.

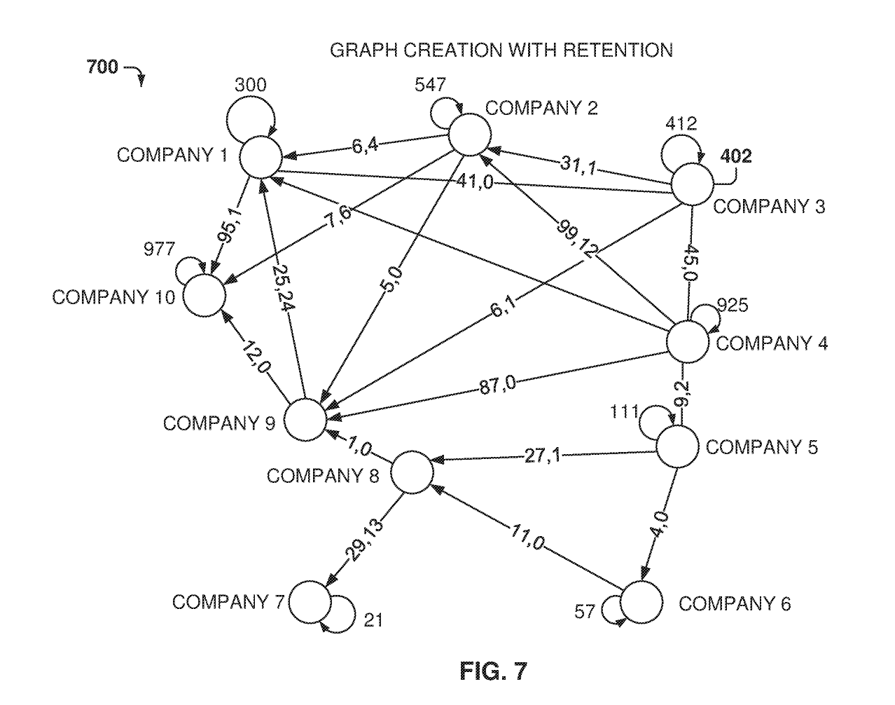

FIG. 7 is a graph 700 for employee transitions between companies with retention links, according to some example embodiments. In some example embodiments, retention is also considered to calculate the company score. Retention refers to the ability of the company to keep skilled employees. The same way that hiring a large number of skilled workers improves the company score, having the ability to keep skilled workers is a measurement of a good company that is able to keep employees satisfied.

In one example embodiment, the graph of FIG. 4 is modified to add retention edges, also referred to as retention links. The retention edges are associated with the number of employees, for the given super-title and period, that remain with the company. In some example embodiment, employees that have been with the company longer than a predetermined threshold period (e.g., two years) of time are considered for the count of the retention edge.

In some example embodiments, the retention threshold period is calculated based on the median retention length per super-title; that is, the retention threshold period is equal to the median of the amount of time that employees with the given skill have stayed at their job, for all companies. This way, the threshold period is linked to the super-title, as some jobs may have more frequent transitions than others (e.g., salespeople may change jobs more often than administrators). The weights for the edges are calculated as before, but now including the retention edges.

Considering retention is important to determining the tractability of the company. For example, if the company has a thousand workers for a given super-title, and the company is retaining those thousand workers for more than three years, the fact that the company may lose a few workers should weigh less than the ability of the company to retain all those workers for a long period of time. Once the graph is calculated, the company scores, when accounting for retention rates, are calculated, as illustrated above with reference to FIG. 6.

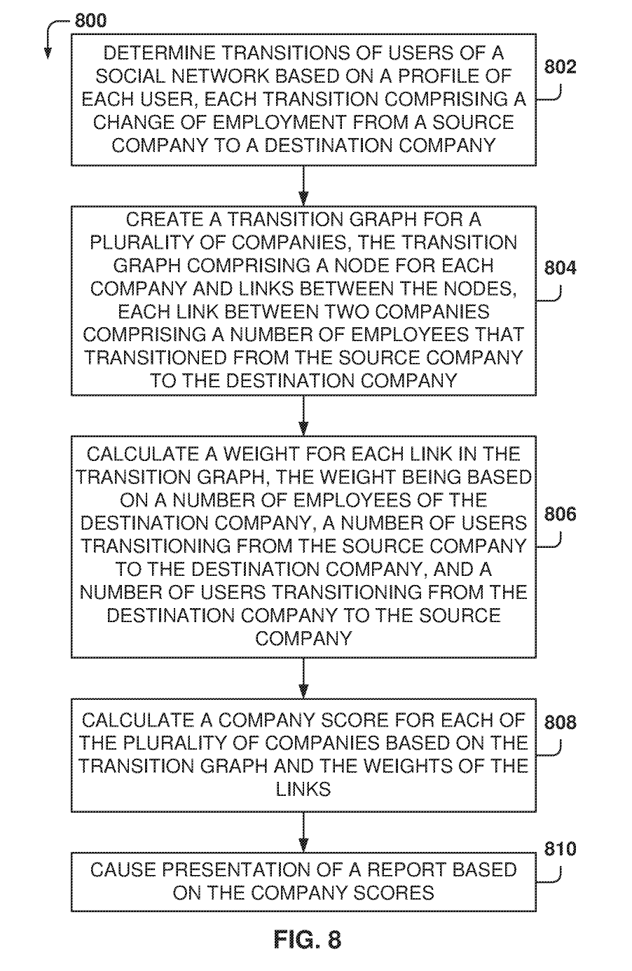

FIG. 8 is a flowchart of a method 800 for generating company-comparison reports based on company rankings for hiring and retaining employees, according to some example embodiments. While the various operations in this flowchart are presented and described sequentially, one of ordinary skill will appreciate that some or all of the operations may be executed in a different order, be combined or omitted, or be executed in parallel.

Operation 802 is to determine, by one or more processors, transitions of users of a social network based on a profile of each user, each transition comprising a change of employment from a source company to a destination company. From operation 802, the method 800 flows to operation 804, where the one or more processors create a transition graph for a plurality of companies, the transition graph comprising a node for each company and links between the nodes, each link between two companies comprising a number of employees that transitioned from the source company to the destination company.

From operation 804, the method 800 flows to operation 806, where the one or more processors calculate a weight for each link in the transition graph, the weight being based on a number of employees of the destination company, a number of users transitioning from the source company to the destination company, and a number of users transitioning from the destination company to the source company.

At operation 808, the one or more processors calculate a company score for each of the plurality of companies based on the transition graph and the weights of the links. Further, at operation 810, the one or more processors cause presentation of a report based on the company scores.

In one example, the weight for the link is proportional to a square root of a maximum company size minus a square root of a size of the destination company.

In one example, the weight for the link is proportional to the number of users transitioning from the source company to the destination company divided by a sum of the number of users transitioning from the source company to the destination company plus the number of users transitioning from the destination company to the source company.

In one example, the weight for the link is proportional to a number of employees retained by the destination company.

In one example, a first node and a second node are connected by two links: a first link based on transitions from the first node to the second node and a second link based on transitions from the second node to the first node.

In one example, determining the transitions for a user further comprises analyzing an employment history of the user from a profile of the user and determining the transitions based on the changes of employment of the user.

In one example, the method 800 further comprises calculating the company score for each period from a plurality of periods, and generating a first report including a graphical representation of the company score across a plurality of periods.

In one example, the transition graph further includes retention links originating and ending in a same company, the retention links representing employees retained by the company for a period of time beyond a predetermined threshold.

In one example, calculating the company score further comprises calculating the company score utilizing a PageRank algorithm, wherein the company score is proportional to a number of incoming links to the node of the company.

In one example, calculating the company score further comprises calculating the company score utilizing an Elo rating system based on the transitions between companies.

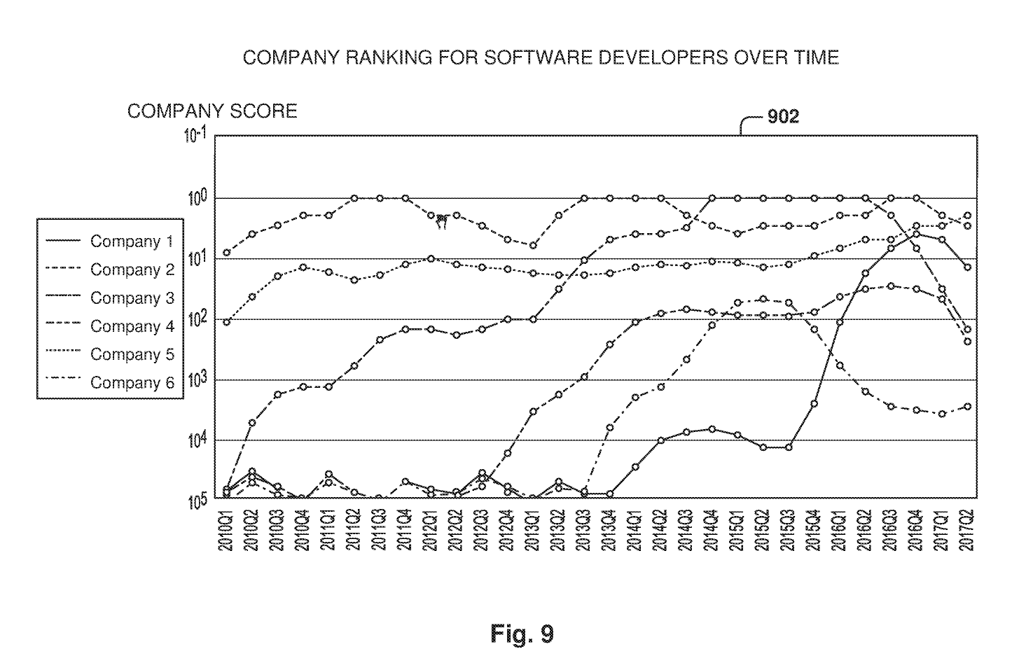

FIG. 9 is a chart showing the evolution of the company score over time for several companies, according to some example embodiments. Many reports may be generated based on the company scores and the flow of employees between companies. The reports may include graphical representations in different formats, such as numerical, textual, tabular, or graphical representations of the data. Additionally, multiple report options are available for generating the reports, such as filtering options that may include super-title, geography, time periods, company characteristics, etc. For example, some reports may include the top 10 companies by number of employees in a given super-title category, or a predefined number of companies selected by the user, or companies with the biggest company score change, etc.

Tracking the company score over time may provide valuable insights into the evolution of a company, because the evolution of the workforce may reflect the financial evolution of the company. For example, companies in financial distress may start terminating employees to save money, and companies in expansion periods may show an increase in the number of employees. A financial analyst may see these trends and decide how to invest or divest from certain companies. This is why the company score may have critical importance for financial investors and company management. Additionally, if a manager identifies that employees are leaving for other companies, the manager may look at the market job trends to increase compensation and be able to retain employees.

FIG. 9 includes chart 902 where the horizontal axis covers data by quarter, and the vertical axis corresponds to the company score in an inverse logarithmic scale (scores at the bottom are close to 0 and the maximum score is 1).

From chart 902, the evolution of the companies over time can be easily observed. For example, Company 1 started growing in the fourth quarter of 2013 and saw a very accelerated growth starting at the third quarter of 2015, although it has shown some decrease in the score in the last two quarters. Further, Company 2 has steady growth and thus a high score over the seven years covered in the chart 902. Company 3 showed gradual growth until it reached the maximum score, but has showed rapid decline over the last four quarters. Company 6 showed rapid growth starting in 2013, but in the third quarter of 2015, the company suffered a large decrease. It is noted that the company score for Company 6 started showing the decline a couple of quarters before Company 6 announced regulatory problems.

The scores calculated are calculated based on quarterly data. However, in some example embodiments, the calculation of the company score may also include data from previous quarters, with some weights utilized to decrease their importance over time. This may be helpful when looking at small companies, as the small companies may only hire a small number of people for certain skill sets. By incorporating data from multiple periods, it is easier to visualize the evolution of the small companies, as well as that of larger companies.

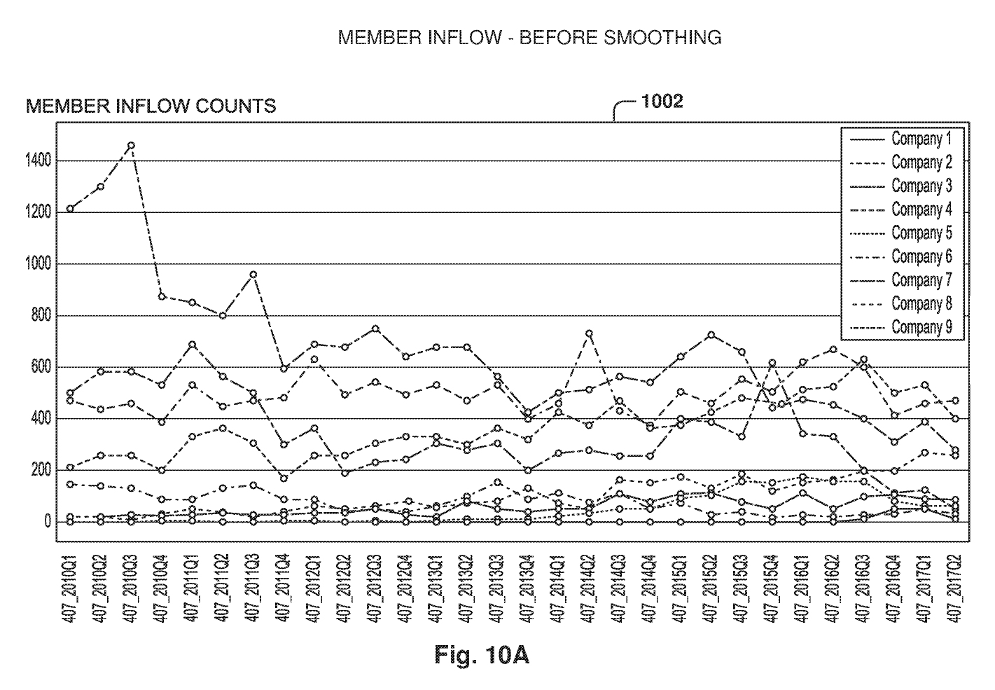

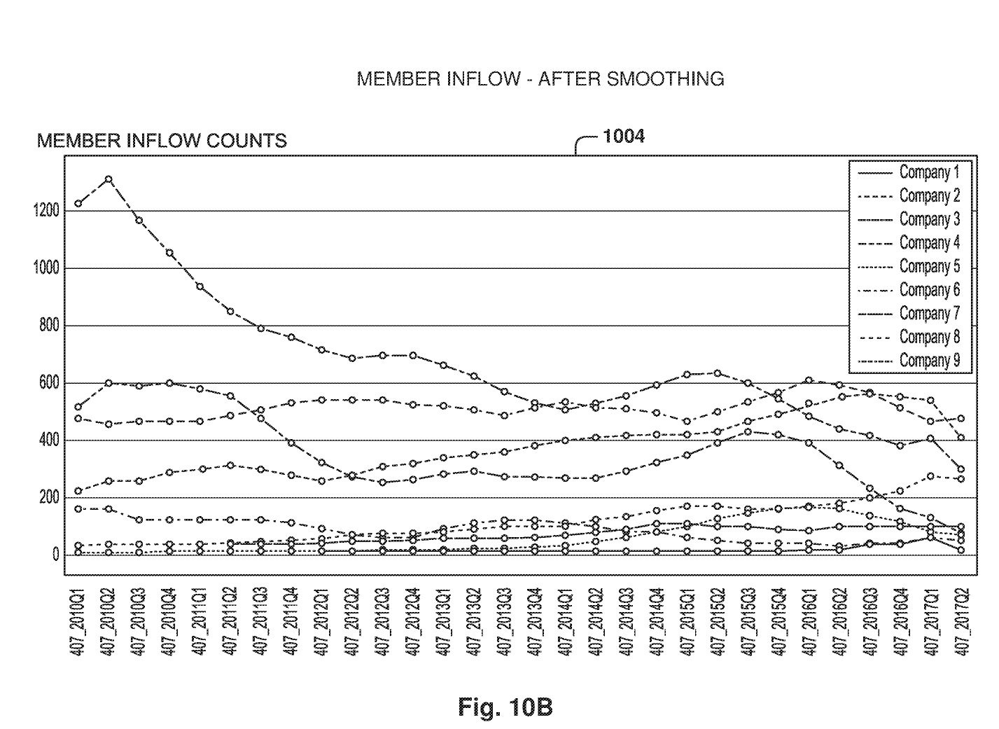

FIG. 10A is a report representing employee inflow over time for a plurality of companies before smoothing, according to some example embodiments. Chart 1002 shows the inflow of employees, per quarter, for a plurality of companies. It is easy to visually analyze how companies grow or shrink over time. Each point in the graph represents the inflow in a particular quarter for the company, and these points are joined by a line to show the evolution.

The chart 1002 of FIG. 10A includes the top nine companies with respect to new employees. Other charts may include the number of outgoing employees, or the net gain or loss of employees.

FIG. 10B is a report representing employee inflow over time for a plurality of companies after smoothing, according to some example embodiments. As seen in FIG. 10A, the inflow data may include many abrupt spikes and valleys. In some example embodiments, data smoothing techniques are utilized to smooth the data over time, such as by calculating a weighted average over a predetermined number of periods, which could extend to the previous periods and future periods.

In one example embodiment, the smoothed inflow count numbers are calculated as:

Iₜ=⅛xₜ₋₂+¼xₜ₋₁+¼xₜ+¼xₜ₊₁+⅛xₜ₊₂

Iₜ represents the weighted smoothed inflow for the period t being calculated, and xᵢ corresponds to the inflow for the period t, where period t−1 is the previous period, period t+1 is the next period, etc. In some example embodiments, Iₜ is used instead of the inflow for the period for the calculation of the company score. Other embodiments may utilize different periods and different weights for the weighted-sum calculation, such as using the current period and the previous two periods, etc., or other exponential smoothing techniques may be utilized.

FIG. 10B shows the inflow chart 1004 after smoothing. In this case, it is easier to appreciate trends over a period of time as the lines tend to include less spikes and valleys.

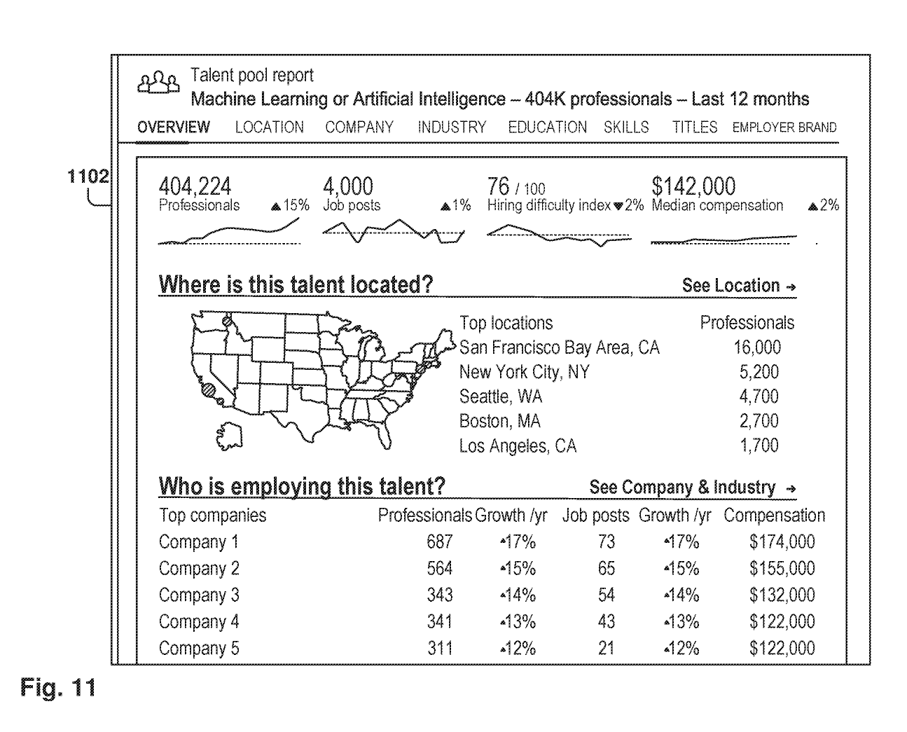

FIG. 11 is a talent pool report 1002, according to some example embodiments. A talent pool report is a type of report that enables finding any population of talent, based on skills, titles, geographies, and industries, while providing insights to help create a talent-acquisition strategy. For example, if the company wants to hire 200 engineers with machine-learning skills, the company may conduct a search to identify where the talent with machine-learning skills is located. This helps the company decide in which locations to hire and establish working teams, or at which locations it will be more expensive to hire employees.

The talent pool report 1102 is an example for a super-title of machine learning or artificial intelligence for the last 12 months. The report 1002 indicates that there are 404,224 professionals that match this skill in the geography of interest, the United States in this case.

The report 1102 includes numbers and graphical representation of the evolution of the professionals, the number of job posts identified in this period for machine learning, a hiring difficulty index, and the median compensation (together with respective growth indicators over the previous year).

Additionally, a map of the United States is shown with circles of varying sizes in proportion to the number of employees at the location, for the identified super-title or super-titles. Additionally, a table shows the tabular representation for the locations and the number of professionals in these locations.

Further yet, the report 1102 includes a list of companies (e.g., top five) that are hiring this type of employee and a table is provided indicating, by company, the number of professionals employed at the company, the percentage growth by year, the number of job posts, the growth by each year in the number of job posts, and the median compensation.

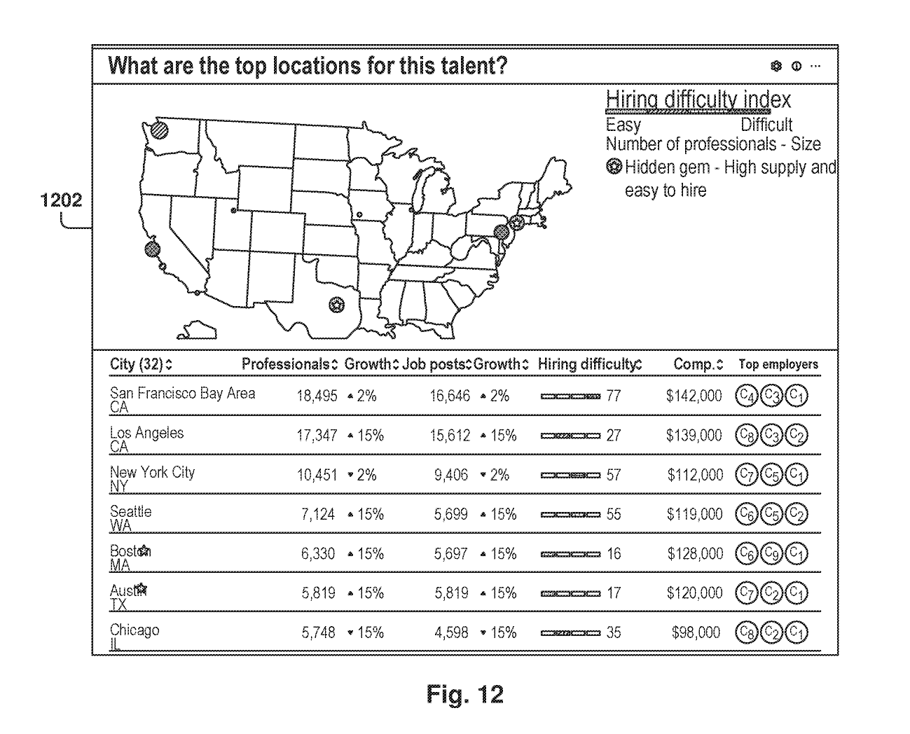

FIG. 12 is a talent geographic map 1202, according to some example embodiments. Supply indicates how many employees are available while demand shows how many companies are hiring for the given super-title. By analyzing supply and demand, it is possible to identify geographies where the number of open job positions is much higher than the supply of skilled workers to field those jobs. In this case, there is a shortage and it will be difficult to hire in that location, or it will be expensive.

In addition, knowing which companies have these workers allows the hiring manager to identify competition for this type of talent. Also, it is possible to see attrition at a company. In this case, employees at this company may be receptive to discussing employment opportunities.

The map 1202 illustrates the top locations for this type of talent. The map 1202 includes circles that are colored based on the hiring difficulty index. Thus, there may be some circles indicating where it is difficult to hire, or other circles that indicate “hidden gems” with a large supply of the desired employees.

A table beneath the map 1202 shows data by location, indicating the number of professionals in the area, the annual growth in number of professionals, the number of job posts, the growth in job posts, a hiring difficulty index based on the supply and demand for the region, average compensation, and the top employers in the region (e.g., C₄, C₃, C₁), which may be represented by name, logo, or both.

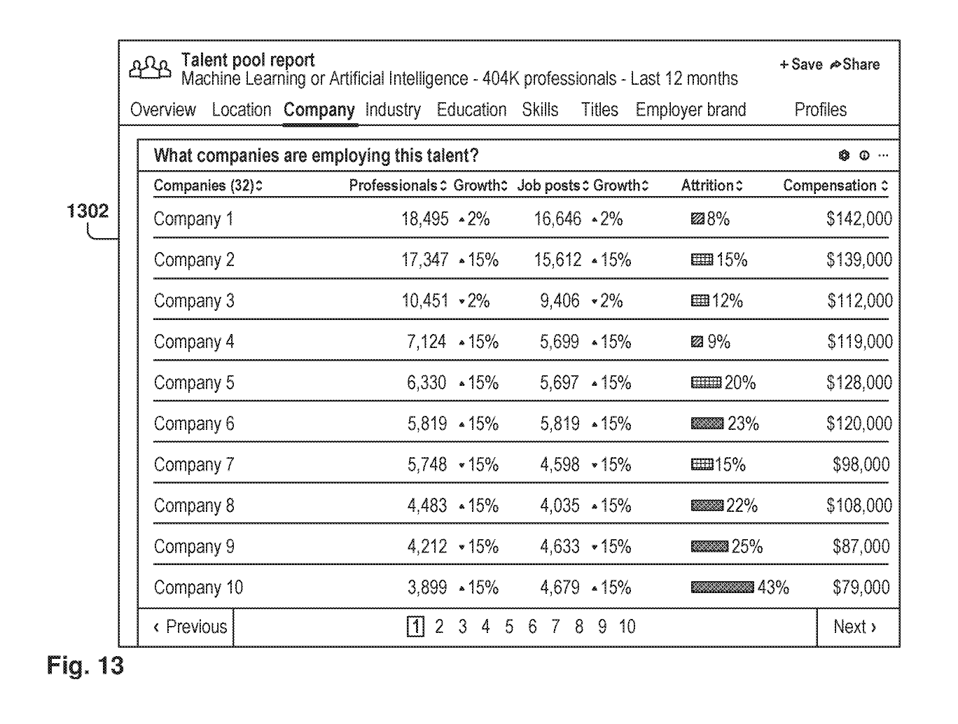

FIG. 13 is a talent-distribution report by company, according to some example embodiments. Chart 1302 shows the companies that are employing machine-learning employees. The data is represented in a table, similar to the table in FIG. 12, but instead of a hiring difficulty index, a column with the attrition rate is provided. The attrition rate is represented numerically and as a graphical horizontal bar that is color-coded based on the attrition rate. For example, company 10 has shown a 43% attrition rate over the last year, indicating that the talent is leaving that company.

It is noted that the report includes 32 companies, although only 10 are presented; however, scrolling options are provided in the user interface for showing additional companies.

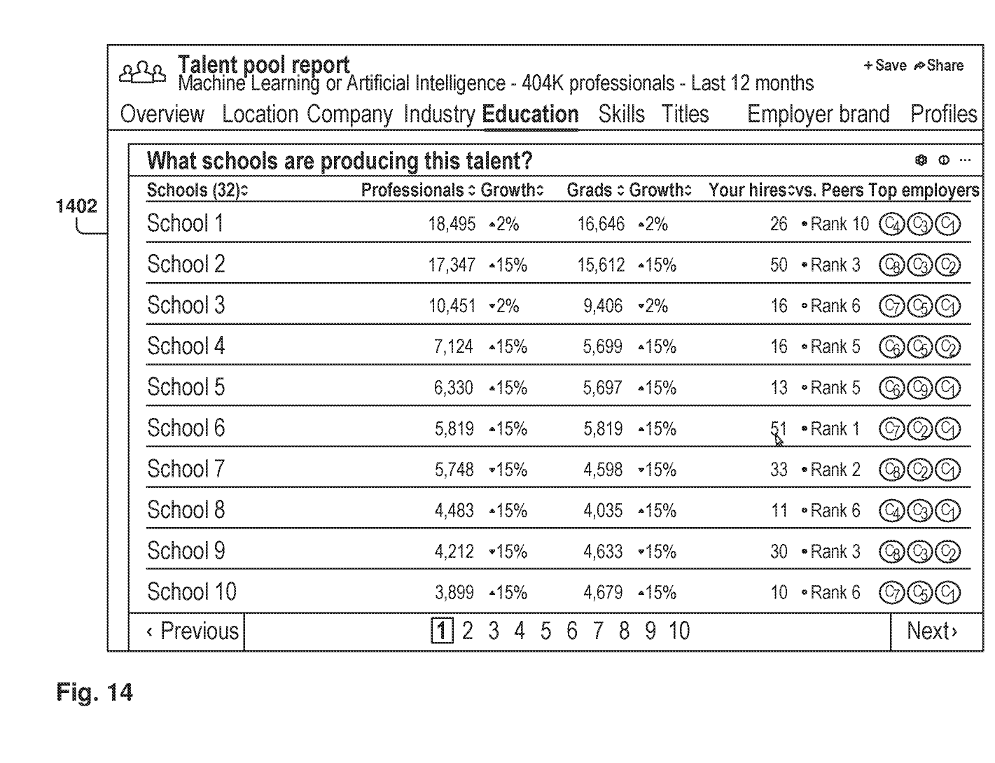

FIG. 14 is a talent report by educational institution, according to some example embodiments. It may also be very informative for a hiring manager to know which schools are providing the desired skills, especially for recent graduates. This way, the hiring manager may intensify hiring activities at the schools generating a large number of graduates with the desired skills.

Chart 1402 shows a talent pool report for the schools “producing” this type of talent. The table includes an entry for each school, and each entry includes the number of professionals who show in their profiles that they are graduates from the school, the annual percentage growth in the number of professionals, the number of recent graduates, the annual growth in the number of recent graduates, the number of hires for the company generating the report, ranking versus other peers, and the top employers indicated by their logos, although other embodiments may include their name. Chart 1402 includes 10 schools (e.g., universities) and scrolling options are provided to show additional schools.

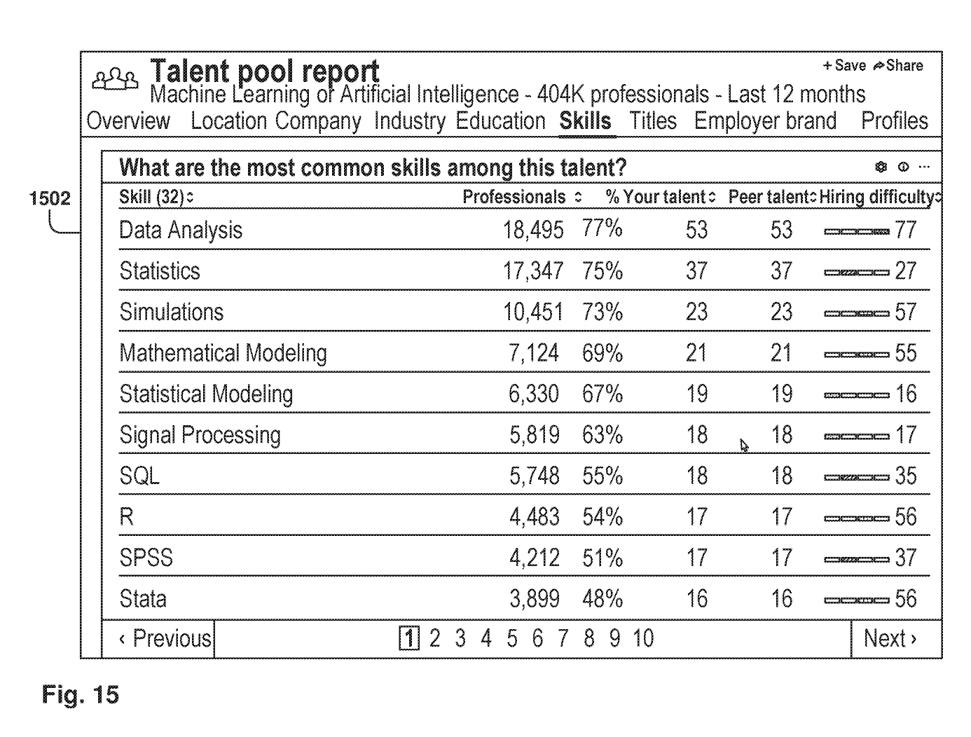

FIG. 15 is a talent report by user skill, according to some example embodiments. Sometimes, it may be difficult to hire the right person for a job, but it may be possible to hire people with similar skills and provide training and mentoring to get the desired skills. Therefore, an analysis of the skills identified by users in the profile may assist in targeting similar types of talent.

Chart 1502 represents the most common skills for a given talent (e.g., machine learning or artificial intelligence). The table includes an entry for each skill and is sorted by the number of professionals showing this skill within the target group. For each entry, the number of professionals identifying the skill is shown, as well as the percentage growth in the number of professionals, the number of employees of the present company showing this skill, the number of peers showing this skill, and the hiring difficulty for hiring employees that possess this skill. The hiring difficulty may be represented as a number and as a sliding scale.

For example, for machine learning, Data Analysis is identified as the most common skill, followed by Statistics, Simulations, Mathematical Modeling, Statistical Modeling, Signal Processing, etc. The table shows that hiring Data Analysis skills is relatively difficult, with a hiring difficulty of 77%. However, people with Statistical Modeling and Signal Processing have relatively low hiring difficulty ratios, so the hiring manager may decide to hire engineers with Statistical Modeling skills and train them to become data scientists.

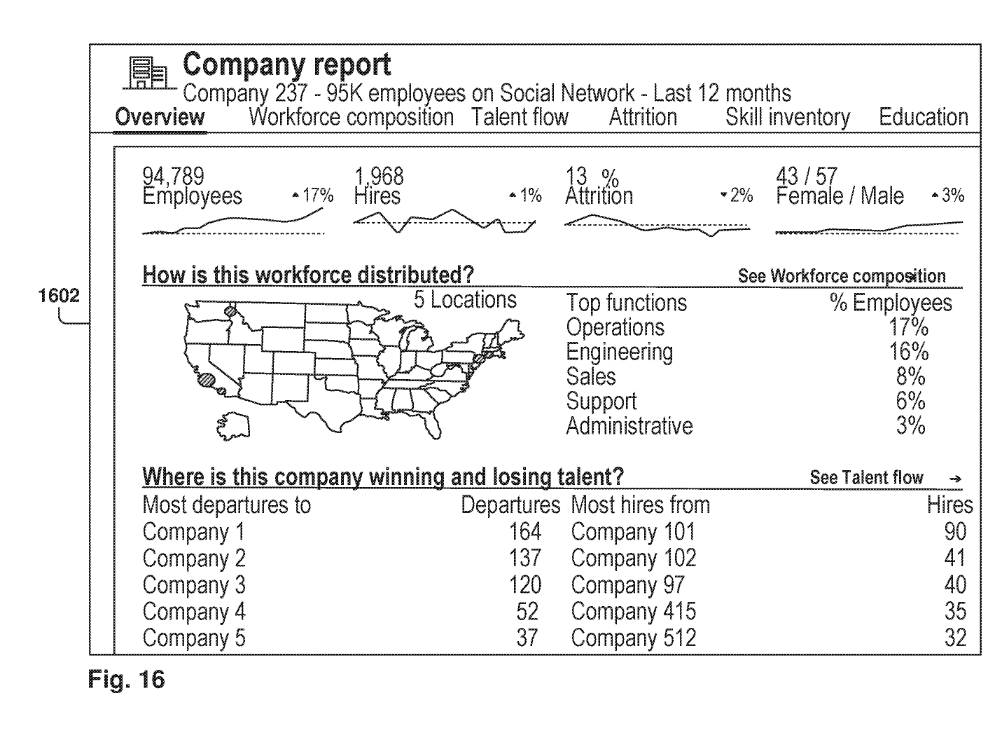

FIG. 16 is a workforce-distribution report for a company, according to some example embodiments. The company report for a particular company (e.g., Company 237 in this example) provides information about the labor composition of the company.

The company report 1602 shows that Company 237 has 94,789 employees with profiles in the social network over the last 12 months. The report 1602 further includes the number of employees, the number of hires, the attrition rate, and the ratio of female to male, with respective linear graphical representations of these values.

Additionally, the company report 1602 shows how the workforce is distributed for this company, illustrated by a map of the United States with circles proportional in size to the concentration of employees. A table next to the map also breaks down the percentage of employees by function, such as Operations, Engineering. Sales, Support, and Administrative.

Further below, a couple of tables indicate where the company is winning and losing talent. A first table on the left shows the companies where employees of Company 237 are going and the number of departures; and a second table on the right shows the companies from which Company 237 is hiring, together with the number of hires within the last 12 months.

Company report 1602 provides a dashboard of information for the company as well as some information about competitors for talent.

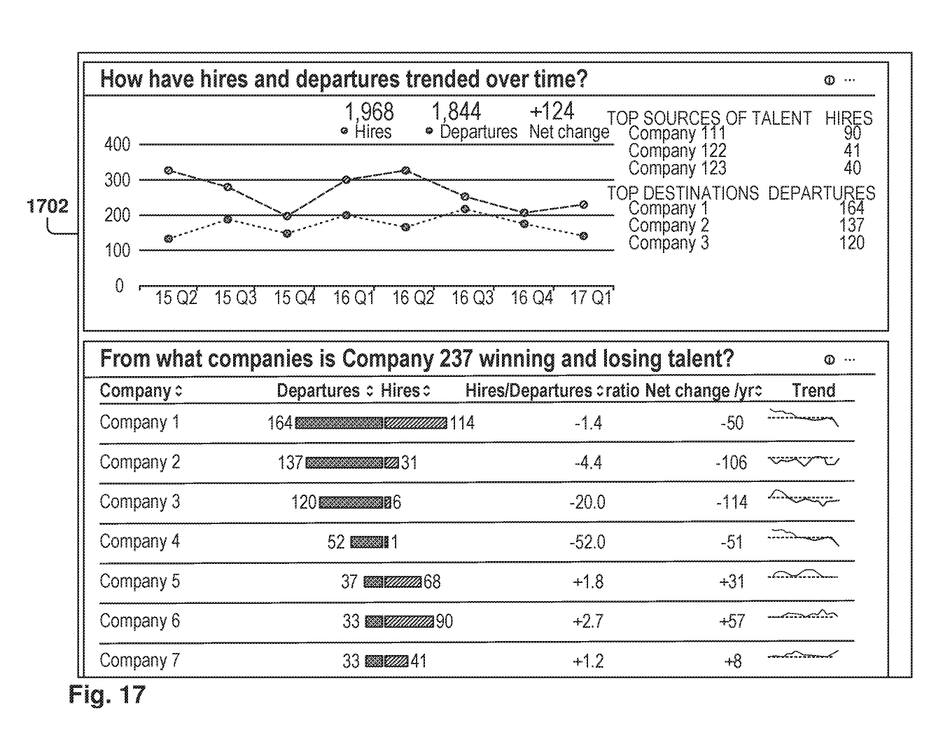

FIG. 17 is a timeline for hires and departures of a given company, according to some example embodiments. Chart 1702 illustrates hires and departure data over time. A top chart shows lines for the number of hires and the number of departures by quarter. Additionally, the companies that are the top sources for talent and the top destinations are shown in tabular form on the right, including the number of hires or departures.

Further, a mixed tabular and graphical summary is presented below to indicate from what companies is Company 237 winning and losing talent. The table includes one entry per company, and for each company a comparison of the departures and hires, a hires to departure ratio, a net change per year for hires or departures (color coded: red for losing talent and black for gaining talent), and a historical line showing evolution over time.

The departures-versus-hires column includes a bar with an origin point. The size of the bar grows to the left in proportion to the number of departures and grows to the right in proportion to the number of hires. Additionally, the actual number of departures or hires is shown next to the bar. This is a very useful graphical representation because it is very easy to quickly see how the company is gaining or losing employees to the respective company in the chart. For example, it is clear to see that Company 237 is losing employees to companies 1-4 but gaining employees with reference to companies 5-7.

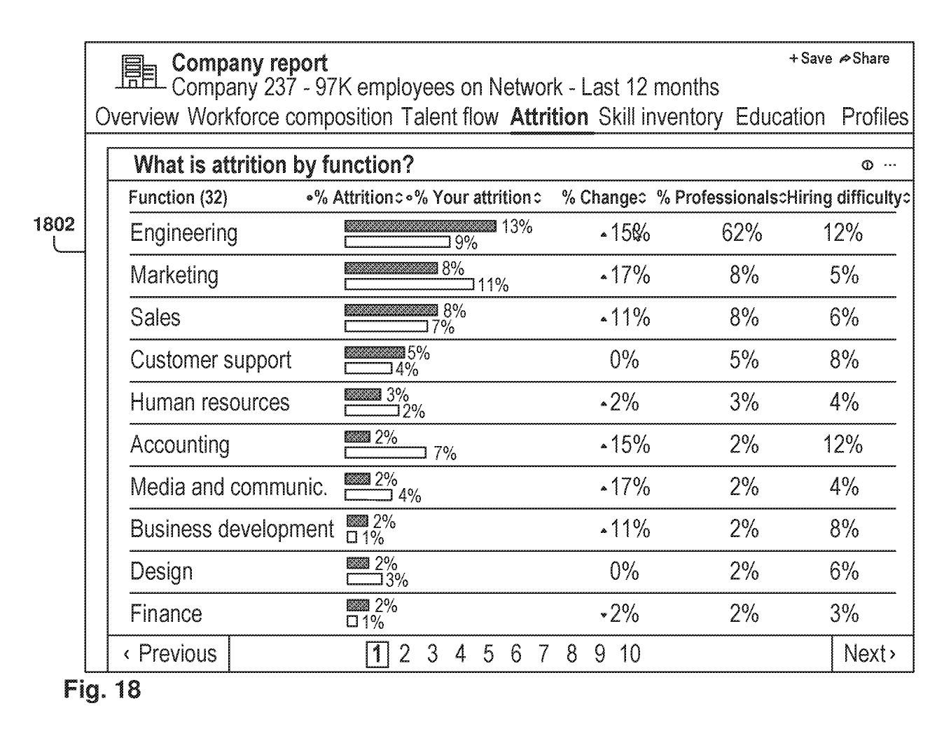

FIG. 18 is a company report by function, according to some example embodiments. Chart 1802 is a company report for a given company (Company 237) that shows the attrition by function. The data is represented in a tabular form with one entry for each function, which include Engineering. Marketing, Sales, Customer support, Human resources, etc.

For each function, two bars are presented, one bar for the attrition rate for the market and another bar for the attrition rate of the company. Other fields include the percentage change in the number of employees, the percentage of professionals within the company, and a hiring difficulty index for the function.

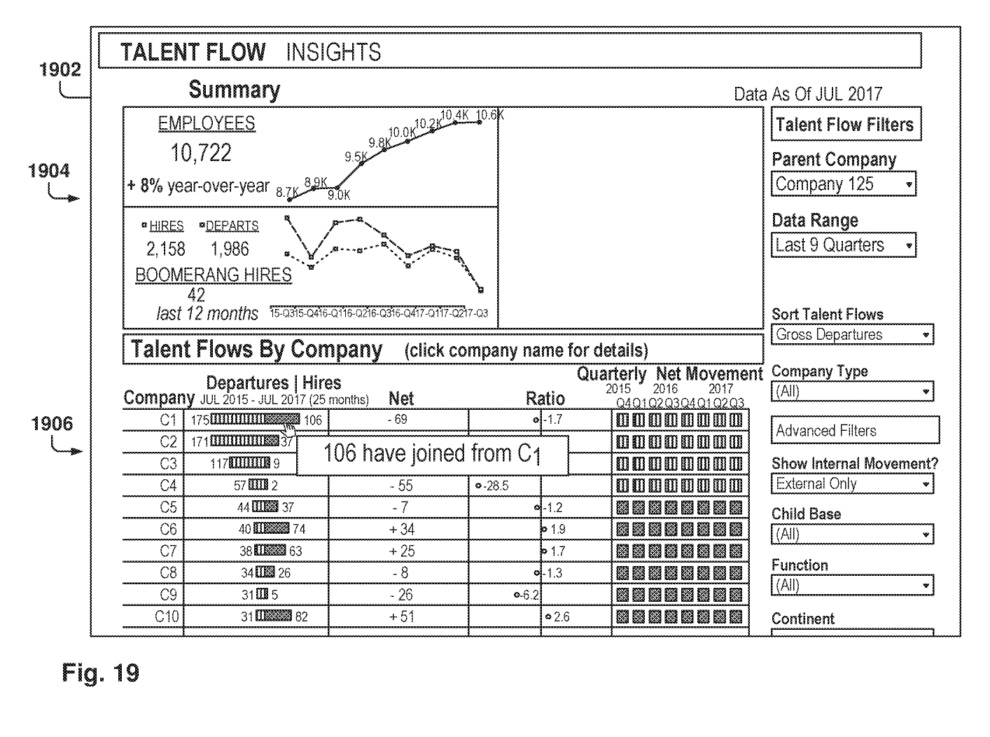

FIG. 19 is a report for talent flow between companies, according to some example embodiments. FIG. 19 provides a dashboard 1902 for talent flow insights. A top section 1904 includes a summary with charts for the number of employees over time, and the number of hires and departures over time. The charts show that the number of employees have steadily grown over time, but that in recent times the number of hires and departures are similar, indicating lack of employee growth at the company.

Further, a bottom section 1906 indicates how the talent flows by company. The table includes an entry for each company with hires or departures with respect to Company 237, and includes the double horizontal bar for departures and hires, as described above with reference to FIG. 17. As shown, if a mouse is placed over the bar, additional information is provided. Other columns indicate the net gain of employees, the ratio between hires and departures, and a color-coded representation of the inflow or outflow, by quarter.

For each quarter, a color-coded square shows an indication of the employee flow. For example, the squares for the first entry for company C₁, show a prevalent red color, which indicates that the company has been losing employees to company C₁. On the other hand, the squares for company C₁₀ are mainly green, indicating that the company has been gaining talent from C₁₀.

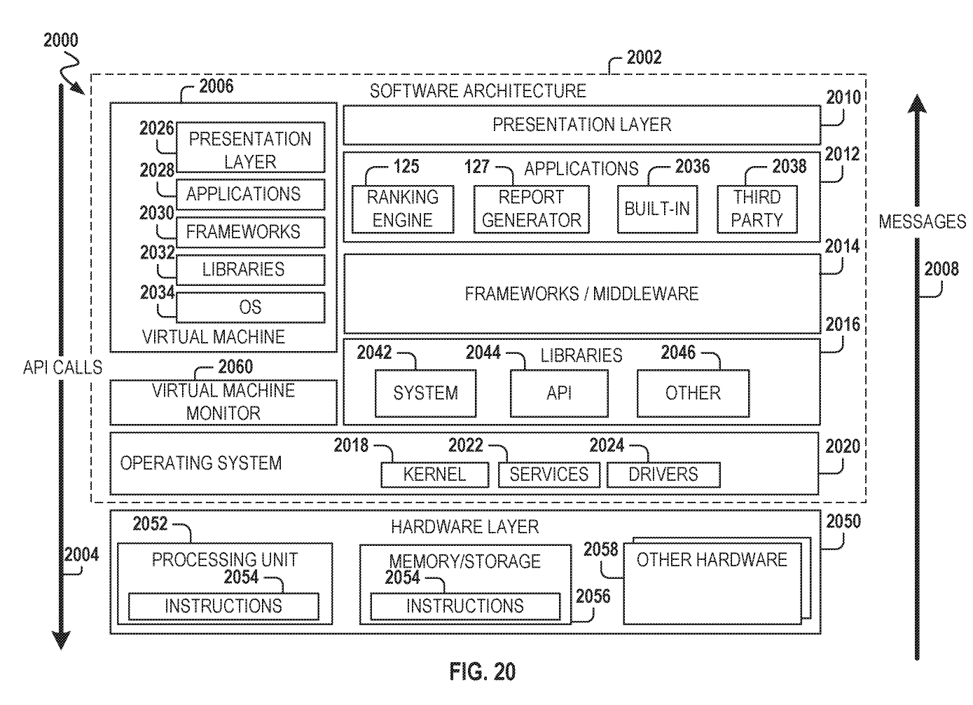

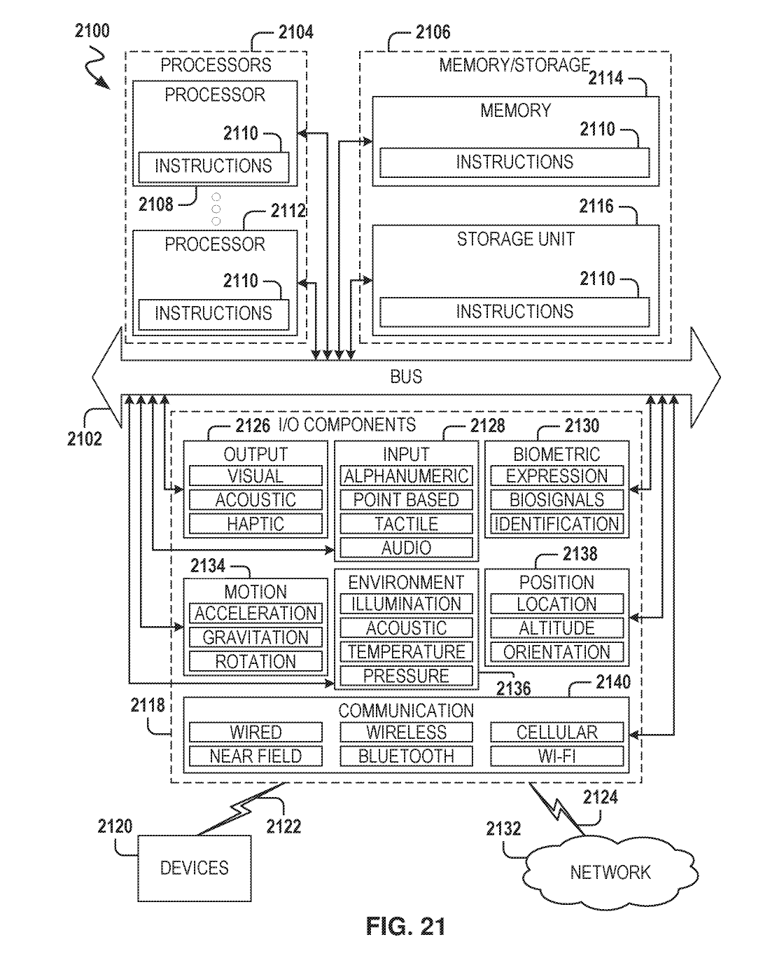

FIG. 20 is a block diagram 2000 illustrating a representative software architecture 2002, which may be used in conjunction with various hardware architectures herein described. FIG. 20 is merely a non-limiting example of a software architecture 2002, and it will be appreciated that many other architectures may be implemented to facilitate the functionality described herein. The software architecture 2002 may be executing on hardware such as a machine 2100 of FIG. 21 that includes, among other things, processors 2104, memory/storage 2106, and input/output (I/O) components 2118. A representative hardware layer 2050 is illustrated and may represent, for example, the machine 2100 of FIG. 21. The representative hardware layer 2050 comprises one or more processing units 2052 having associated executable instructions 2054. The executable instructions 2054 represent the executable instructions of the software architecture 2002, including implementation of the methods, modules, and so forth of FIGS. 1-8. The hardware layer 2050 also includes memory and/or storage modules 2056, which also have the executable instructions 2054. The hardware layer 2050 may also comprise other hardware 2058, which represents any other hardware of the hardware layer 2050, such as the other hardware illustrated as part of the machine 2100.

In the example architecture of FIG. 20, the software architecture 2002 may be conceptualized as a stack of layers where each layer provides particular functionality. For example, the software architecture 2002 may include layers such as an operating system 2020, libraries 2016, frameworks/middleware 2014, applications 2012, and a presentation layer 2010. Operationally, the applications 2012 and/or other components within the layers may invoke application programming interface (API) calls 2004 through the software stack and receive a response, returned values, and so forth illustrated as messages 2008 in response to the API calls 2004. The layers illustrated are representative in nature, and not all software architectures have all layers. For example, some mobile or special-purpose operating systems may not provide a frameworks/middleware 2014 layer, while others may provide such a layer. Other software architectures may include additional or different layers.

The operating system 2020 may manage hardware resources and provide common services. The operating system 2020 may include, for example, a kernel 2018, services 2022, and drivers 2024. The kernel 2018 may act as an abstraction layer between the hardware and the other software layers. For example, the kernel 2018 may be responsible for memory management, processor management (e.g., scheduling), component management, networking, security settings, and so on. The services 2022 may provide other common services for the other software layers. The drivers 2024 may be responsible for controlling or interfacing with the underlying hardware. For instance, the drivers 2024 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 2016 may provide a common infrastructure that may be utilized by the applications 2012 and/or other components and/or layers. The libraries 2016 typically provide functionality that allows other software modules to perform tasks in an easier fashion than by interfacing directly with the underlying operating system 2020 functionality (e.g., kernel 2018, services 2022, and/or drivers 2024). The libraries 2016 may include system libraries 2042 (e.g., C standard library) that may provide functions such as memory allocation functions, string manipulation functions, mathematic functions, and the like. In addition, the libraries 2016 may include API libraries 2044 such as media libraries (e.g., libraries to support presentation and manipulation of various media formats such as MPEG4, H.264, MP3, AAC, AMR, JPG, PNG), graphics libraries (e.g., an OpenGL framework that may be used to render two-dimensional and three-dimensional graphic content on a display), database libraries (e.g., SQLite that may provide various relational database functions), web libraries (e.g., WebKit that may provide web browsing functionality), and the like. The libraries 2016 may also include a wide variety of other libraries 2046 to provide many other APIs to the applications 2012 and other software components/modules.

The frameworks 2014 (also sometimes referred to as middleware) may provide a higher-level common infrastructure that may be utilized by the applications 2012 and/or other software components/modules. For example, the frameworks 2014 may provide various graphic user interface (GUI) functions, high-level resource management, high-level location services, and so forth. The frameworks 2014 may provide a broad spectrum of other APIs that may be utilized by the applications 2012 and/or other software components/modules, some of which may be specific to a particular operating system or platform.

The applications 2012 include the ranking engine 125, the report generator 127, and other modules as shown in FIG. 1 (not shown), built-in applications 2036, and third-party applications 2038. Examples of representative built-in applications 2036 may include, but are not limited to, a contacts application, a browser application, a book reader application, a location application, a media application, a messaging application, and/or a game application. The third-party applications 2038 may include any of the built-in applications 2036 as well as a broad assortment of other applications. In a specific example, the third-party application 2038 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 2038 may invoke the API calls 2004 provided by the mobile operating system such as the operating system 2020 to facilitate functionality described herein.

The applications 2012 may utilize built-in operating system functions (e.g., kernel 2018, services 2022, and/or drivers 2024), libraries (e.g., system libraries 2042, API libraries 2044, and other libraries 2046), or frameworks/middleware 2014 to create user interfaces to interact with users of the system. Alternatively, or additionally, in some systems, interactions with a user may occur through a presentation layer, such as the presentation layer 2010. In these systems, the application/module “logic” may be separated from the aspects of the application/module that interact with a user.

Some software architectures utilize virtual machines. In the example of FIG. 20, this is illustrated by a virtual machine 2006. A virtual machine creates a software environment where applications/modules may execute as if they were executing on a hardware machine (such as the machine 2100 of FIG. 21, for example). The virtual machine 2006 is hosted by a host operating system (e.g., the operating system 2020 in FIG. 20) and typically, although not always, has a virtual machine monitor 2060, which manages the operation of the virtual machine 2006 as well as the interface with the host operating system (e.g., the operating system 2020). A software architecture executes within the virtual machine 2006, such as an operating system 2034, libraries 2032, frameworks/middleware 2030, applications 2028, and/or a presentation layer 2026. These layers of software architecture executing within the virtual machine 2006 may be the same as corresponding layers previously described or may be different.

FIG. 21 is a block diagram illustrating components of a machine 2100, according to some example embodiments, able to read instructions from a machine-readable medium (e.g., a machine-readable storage medium) and perform any one or more of the methodologies discussed herein. Specifically, FIG. 21 shows a diagrammatic representation of the machine 2100 in the example form of a computer system, within which instructions 2110 (e.g., software, a program, an application, an applet, an app, or other executable code) for causing the machine 2100 to perform any one or more of the methodologies discussed herein may be executed. For example, the instructions 2110 may cause the machine 2100 to execute the flow diagrams of FIGS. 6 and 8. Additionally, or alternatively, the instructions 2110 may implement the programs of the social networking server 112, and so forth. The instructions 2110 transform the general, non-programmed machine 2100 into a particular machine 2100 programmed to carry out the described and illustrated functions in the manner described.

In alternative embodiments, the machine 2100 operates as a standalone device or may be coupled (e.g., networked) to other machines. In a networked deployment, the machine 2100 may operate in the capacity of a server machine or a client machine in a server-client network environment, or as a peer machine in a peer-to-peer (or distributed) network environment. The machine 2100 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 2110, sequentially or otherwise, that specify actions to be taken by the machine 2100. Further, while only a single machine 2100 is illustrated, the term “machine” shall also be taken to include a collection of machines 2100 that individually or jointly execute the instructions 2110 to perform any one or more of the methodologies discussed herein.

The machine 2100 may include processors 2104, memory/storage 2106, and I/O components 2118, which may be configured to communicate with each other such as via a bus 2102. In an example embodiment, the processors 2104 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 2108 and a processor 2112 that may execute the instructions 2110. The term “processor” is intended to include multi-core processors that may comprise two or more independent processors (sometimes referred to as “cores”) that may execute instructions contemporaneously. Although FIG. 21 shows multiple processors 2104, the machine 2100 may include a single processor with a single core, a single processor with multiple cores (e.g., a multi-core processor), multiple processors with a single core, multiple processors with multiple cores, or any combination thereof.

The memory/storage 2106 may include a memory 2114, such as a main memory, or other memory storage, and a storage unit 2116, both accessible to the processors 2104 such as via the bus 2102. The storage unit 2116 and memory 2114 store the instructions 2110 embodying any one or more of the methodologies or functions described herein. The instructions 2110 may also reside, completely or partially, within the memory 2114, within the storage unit 2116, within at least one of the processors 2104 (e.g., within the processor's cache memory), or any suitable combination thereof, during execution thereof by the machine 2100. Accordingly, the memory 2114, the storage unit 2116, and the memory of the processors 2104 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store the instructions 2110. The term “machine-readable medium” shall also be taken to include any medium, or combination of multiple media, that is capable of storing instructions (e.g., instructions 2110) for execution by a machine (e.g., machine 2100), such that the instructions, when executed by one or more processors of the machine (e.g., processors 2104), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 2118 may include a wide variety of components to receive input, provide output, produce output, transmit information, exchange information, capture measurements, and so on. The specific I/O components 2118 that are included in a particular machine will depend on the type of machine. For example, portable machines such as mobile phones will likely include a touch input device or other such input mechanisms, while a headless server machine will likely not include such a touch input device. It will be appreciated that the I/O components 2118 may include many other components that are not shown in FIG. 21. The I/O components 2118 are grouped according to functionality merely for simplifying the following discussion, and the grouping is in no way limiting. In various example embodiments, the I/O components 2118 may include output components 2126 and input components 2128. The output components 2126 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2128 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 2118 may include biometric components 2130, motion components 2134, environmental components 2136, or position components 2138 among a wide array of other components. For example, the biometric components 2130 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 2134 may include acceleration sensor components (e.g., accelerometer), gravitation sensor components, rotation sensor components (e.g., gyroscope), and so forth. The environmental components 2136 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 2138 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2118 may include communication components 2140 operable to couple the machine 2100 to a network 2132 or devices 2120 via a coupling 2124 and a coupling 2122, respectively. For example, the communication components 2140 may include a network interface component or other suitable device to interface with the network 2132. In further examples, the communication components 2140 may include wired communication components, wireless communication components, cellular communication components, Near Field Communication (NFC) components. Bluetooth® components (e.g., Bluetooth® Low Energy), Wi-Fi® components, and other communication components to provide communication via other modalities. The devices 2120 may be another machine or any of a wide variety of peripheral devices (e.g., a peripheral device coupled via a USB).

Moreover, the communication components 2140 may detect identifiers or include components operable to detect identifiers. For example, the communication components 2140 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2140, such as location via Internet Protocol (IP) geo-location, location via Wi-Fi, signal triangulation, location via detecting an NFC beacon signal that may indicate a particular location, and so forth.

In various example embodiments, one or more portions of the network 2132 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi®) network, another type of network, or a combination of two or more such networks. For example, the network 2132 or a portion of the network 2132 may include a wireless or cellular network and the coupling 2124 may be a Code Division Multiple Access (CDMA) connection, a Global System for Mobile communications (GSM) connection, or another type of cellular or wireless coupling. In this example, the coupling 2124 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 2110 may be transmitted or received over the network 2132 using a transmission medium via a network interface device (e.g., a network interface component included in the communication components 2140) and utilizing any one of a number of well-known transfer protocols (e.g., hypertext transfer protocol (HTTP)). Similarly, the instructions 2110 may be transmitted or received using a transmission medium via the coupling 2122 (e.g., a peer-to-peer coupling) to the devices 2120. The term “transmission medium” shall be taken to include any intangible medium that is capable of storing, encoding, or carrying the instructions 2110 for execution by the machine 2100, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is provisionally claimed is:

1. A method comprising:
determining, by one or more processors, transitions of users of a social network based on a profile of each user, each transition comprising a change of employment from a source company to a destination company;
creating, by the one or more processors, a transition graph for a plurality of companies, the transition graph comprising a node for each company and links between the nodes, each link between two companies comprising a number of employees that transitioned from the source company to the destination company;
calculating, by the one or more processors, a weight for each link in the transition graph, the weight being based on a number of employees of the destination company, a number of users transitioning from the source company to the destination company, and a number of users transitioning from the destination company to the source company;
calculating, by the one or more processors, a company score for each of the plurality of companies based on the transition graph and the weights of the links; and
causing, by the one or more processors, presentation of a report based on the company scores.

2. The method as recited in claim 1, wherein the weight for the link is proportional to a square root of a maximum company size minus a square root of a size of the destination company.

3. The method as recited in claim 1, wherein the weight for the link is proportional to the number of users transitioning from the source company to the destination company divided by a sum of the number of users transitioning from the source company to the destination company plus the number of users transitioning from the destination company to the source company.

4. The method as recited in claim 1, wherein the weight for the link is proportional to a number of employees retained by the destination company.

5. The method as recited in claim 1, wherein a first node and a second node are connected by two links: a first link based on transitions from the first node to the second node, and a second link based on transitions from the second node to the first node.

6. The method as recited in claim 1, where determining the transitions for a user further comprises:
analyzing an employment history of the user from a profile of the user; and
determining the transitions based on the changes of employment of the user.

7. The method as recited in claim 1, further comprising:
calculating the company score for each period from a plurality of periods; and
generating a first report including a graphical representation of the company score across a plurality of periods.

8. The method as recited in claim 1, wherein the transition graph further includes retention links originating and ending in a same company, the retention links representing employees retained by the company for a period of time beyond a predetermined threshold.

9. The method as recited in claim 1, wherein calculating the company score further comprises:
calculating the company score utilizing a PageRank algorithm, wherein the company score is proportional to a number of incoming links to the node of the company.

10. The method as recited in claim 1, wherein calculating the company score further comprises:
calculating the company score utilizing an Elo rating system based on transitions between companies.

11. A system comprising:
a memory comprising instructions; and
one or more computer processors, wherein the instructions, when executed by the one or more computer processors, cause the one or more computer processors to perform operations comprising:
determining transitions of users of a social network based on a profile of each user, each transition comprising a change of employment from a source company to a destination company;
creating a transition graph for a plurality of companies, the transition graph comprising a node for each company and links between the nodes, each link between two companies comprising a number of employees that transitioned from the source company to the destination company,
calculating a weight for each link in the transition graph, the weight being based on a number of employees of the destination company, a number of users transitioning from the source company to the destination company, and a number of users transitioning from the destination company to the source company;
calculating a company score for each of the plurality of companies based on the transition graph and the weights of the links; and
causing presentation of a report based on the company scores.

12. The system as recited in claim 11, wherein the weight for the link is proportional to a square root of a maximum company size minus a square root of a size of the destination company.

13. The system as recited in claim 11, wherein the weight for the link is proportional to the number of users transitioning from the source company to the destination company divided by a sum of the number of users transitioning from the source company to the destination company plus the number of users transitioning from the destination company to the source company.

14. The system as recited in claim 11, wherein the weight for the link is proportional to a number of employees retained by the destination company.

15. The system as recited in claim 11, wherein the instructions further cause the one or more computer processors to perform operations comprising:
calculating the company score for each period from a plurality of periods; and
generating a first report including a graphical representation of the company score across a plurality of periods.

16. A non-transitory machine-readable storage medium including instructions that, when executed by a machine, cause the machine to perform operations comprising:
determining transitions of users of a social network based on a profile of each user, each transition comprising a change of employment from a source company to a destination company;
creating a transition graph for a plurality of companies, the transition graph comprising a node for each company and links between the nodes, each link between two companies comprising a number of employees that transitioned from the source company to the destination company;
calculating a weight for each link in the transition graph, the weight being based on a number of employees of the destination company, a number of users transitioning from the source company to the destination company, and a number of users transitioning from the destination company to the source company;
calculating a company score for each of the plurality of companies based on the transition graph and the weights of the links; and
causing presentation of a report based on the company scores.

17. The machine-readable storage medium as recited in claim 16, wherein the weight for the link is proportional to a square root of a maximum company size minus a square root of a size of the destination company.

18. The machine-readable storage medium as recited in claim 16, wherein the weight for the link is proportional to the number of users transitioning from the source company to the destination company divided by a sum of the number of users transitioning from the source company to the destination company plus the number of users transitioning from the destination company to the source company.

19. The machine-readable storage medium as recited in claim 16, wherein the weight for the link is proportional to a number of employees retained by the destination company.

20. The machine-readable storage medium as recited in claim 16, wherein the machine further performs operations comprising:
calculating the company score for each period from a plurality of periods; and
generating a first report including a graphical representation of the company score across a plurality of periods.
